(19) United States
(12) Patent Application Publication
(10) Pub. No.: US 2022/0048215 A1
(43) Pub. Date: Feb. 17, 2022

(54) Automated Machine for Cut to Length Wax Extrusions

(71) Applicants: R. Brandon Bell, West Palm Beach, FL (US); Attilio Tebano, MIAMI BEACH, FL (US); Daniel Britti, MIAMI BEACH, FL (US)

(72) Inventors: R. Brandon Bell, West Palm Beach, FL (US); Attilio Tebano, MIAMI BEACH, FL (US); Daniel Britti, MIAMI BEACH, FL (US)

(21) Appl. No.: 16/990,901

(22) Filed: Aug. 11, 2020

(51) Int. Cl. B26D 7/10; B26D 7/08; B26D 7/06; B26D 1/08; B26D 5/12

(52) U.S. Cl. CPC B26D 7/10; B26D 7/088; B26D 5/12; B26D 1/08; B26D 7/0683; B26D 7/0625

(57) ABSTRACT

A machine used to convey and cut thin walled wax extrusions. The machine is adjustable and capable of short rapid cuts while maintaining square and consistent finish on the surface of the wax as the knife passes through. The machine may be particularly useful for any wax extrusion requiring a smooth and square cut while remaining capable of running multiple strands in one process to increase production capabilities of a single machine.

### BACKGROUND OF THE INVENTION

### 1A. Field of the Invention

This disclosure pertains to a machine used in the continuous conveying and cutting of short wax or similar low melt strength extrusions. More particularly this machine allows the wax extrusions to be conveyed and cut to length, and may be used the parts are being extruded in a continuous manner with various adjustability to modify the wax product attributes such as: cut length, diameter, surface finish and the like. The machine may allow the user to also accommodate larger amounts of wax parts being conveyed and cut by either increasing the speed of the machinery or increasing the number of extruded strands entering the machine at one time, while not sacrificing cut quality.

### 2. Description of Prior Art

Various types of machinery have existed previously to convey and/or pull extrusions and then cut them to length. The pulling aspect of the machinery (puller) may involve a pair of belts which contact the exterior of the extrusion to pull it at a set speed. A pair of nip wheels setup as a pinch assembly may also be used. In both instances an electric motor of some type will be utilized to drive, and control speed of the belts. The cutting aspect (cutter) has previously involved a variety of methods such as a rotating knife, shear, rotating cut off wheel or similar. All of these methods combined with each other has yielded many combinations of pulling-cutting machinery used in the extrusion industry for various products and materials.

In recent decades, the extrusion industry has continued to grow and the need for new and improved methods of pulling and cutting products of various types. New types of extrusions are being invented every year with new materials for new products. Prior art has shown designs which incorporate the aforementioned devices. These methods have worked well for thermoplastics, rubber and silicone but did not produce desired results on extruded wax profiles or other soft and/or low melt strength material. This is especially apparent on various wax profiles which may have a hollow inner geometry, similar to a tube or some other shape where the center portion is considerably void. The resulting thin wall wax extrusion becomes difficult to cut for a number of reasons.

Common methods for cutting thin walled plastic extrusion parts with short lengths typically involves a set of 2 round bushings inline with center orifice, which a rotating knife passes through the gap between. The extrudate is fed through the center orifice of said cutter bushings by the puller (or driven pinch wheel). The bushings have a center orifice which the extrusion is conveyed through by the aforementioned pulling machine. The blade passes through a narrow gap created by the inline bushings and promotes a shearing (cutting) of the part. This method works well on the majority of parts in the plastic extrusion industry that have adequate internal strength to avoid being terminally distorted by the impact of the cutting knife. Drawbacks are noticed on plastic parts with low durometer, increased tackiness and especially when also having a thin wall geometry of approximately 0.020″ or less. Other instances that involve a shear, a guillotine style cutter, work but primarily for flat sheet extrusions or generally flat extrusions. Drawbacks on the cutting shear include being limited in production speed because the cutting blade in this instance interrupts the extrusion typically longer than the rotating knife cutter mentioned above especially considering the blade also has to change directions across the face of the surface, versus just passing straight through as the rotating knife does.

The need to convey and cut thin walled wax extrusions has become more apparent as alternatives to petroleum based materials are selected. Sustainably harvested beeswax has been used to create a number of products, some of which are extruded and cut to length such as a filter for a cigarette. Thus, the ability to cut the wax extrusions crisp, square and rapidly has become necessary.

### SUMMARY OF THE INVENTION

The subject matter of this application may involve, in some cases, interrelated products, alternative solutions to a particular problem, and/or a plurality of different uses of a single system or article.

It is an object of the present invention to provide a feasible way to convey and cut wax extrusions successfully, in a repeatable, square, crisp fashion without creating smudges, smears, cuffs or variance in dimensions. While the material to be cut in this disclosure is often referred to as “wax” or “beeswax” it should be understood that other materials may be cut with the cutting machine disclosed herein without straying from the scope of this invention. Indeed any material may be cut with this cutting machine, in particular low melt strength materials in which cutting is aided by a heated blade to provide a more clean and swift cut. It is another object of the system to accurately convey the extruded wax in a manner that does not result in breakage due to lack of melt strength.

The present disclosure utilizes a puller, also called a conveyor. The addition of product to the puller results in some assistance in maintaining a production speed, however the addition of gravity and also a spring loaded idler further yields a simple cost effective conveying system to maintain consistent pull while allowing some slippage to occur without breakage. The idler can aide in maintaining certain dimensions required on the product, or textures. The combination is unique and there is no previous evidence of its design in prior art. At the exit of the conveyor is a cutting apparatus which, in one embodiment, utilizes an air cylinder-driven heated blade which moves and cuts in reciprocating fashion. The heated blade utilizes Ohm's law to create localized heat to aide in the sharp knife passing through the wax extrusion. Without adequate heat, the thin blade will smear, smudge or deform the wax extrusion in an undesirable fashion. The addition of heating the thin reciprocating blade creates very desirable results while allowing the extrudate to be gently conveyed through the cutting apparatus.

It should be understood that varying blade geometries may be utilized and in some instances it is possible that there may be more than one blade. In some embodiments, blades may change in shape and operation depending on several variables but the heating of the blade in this application is unique and may be particularly advantageous.

In one embodiment, the heat in the knife is controlled by changing the amount of amperage which passes through it. Commonly known devices, such as a rheostat, will enable the variance of current through the blade. The blade may thus operate as a heater as well as a sharp double sided knife. By varying the correct combination of voltage and amperage, Ohm's law shows the resulting current can allow a repeatable parameter in the process.

In some embodiments, varying the voltage may not be necessary, if the correct sized blade is utilized for the associated voltage. The adjustability may not be necessary for specific applications. The heated blade is thin enough, hot enough and fast enough to successfully cut the wax extrusions much more successfully than prior art at constant parameters.

Some embodiments may have a longer blade, for which multiple strands of extrudate may be cut simultaneously. This allows the speed of the combined extrudate to remain low, but increases the quantity of parts being cut per minute without sacrificing quality. The blade will pass across a bushing which may hold a plurality of orifices. Each orifice will guide the extrudate and maintain a center position.

In one embodiment, the bushing may be heated to allow the wax to melt while it conveys through. The outer melted portion of the wax will act as a continuous lubricant to easily aide in the passing of the extrudate past the knife.

In another embodiment, the reciprocating knife assembly may be driven by pneumatic air cylinder. The air cylinder may be controlled with various known prior art such as timer or length counting device for repeatable part length.

In yet another embodiment, the reciprocating knife assembly may be electrically driven by an electronic cylinder.

Another embodiment, the reciprocating knife assembly may be driven by a cam assembly. The cam assembly may consist of electronic motor or similar, which drives various cam with linkage to move knife in reciprocating fashion.

In another aspect of the invention, pulling of the extrudate is done with a single belt conveyor. The melt strength of the wax extrusion does not make it as easy to manipulate as other thermoplastics for example. Simply pulling the wax at a constant speed may result in increased breakage causing the line to go down or inconsistent product diameters.

In yet another embodiment, the need to utilize the density of wax and gravity calls for the need to adjust the entire pulling-cutting machine downwards at an angle, such that gravity provides assistance in the process. This also helps eject the cut parts after being sliced by the heated knife.

It should be understood that some wax extrusions may not require the downward angle of the conveyor, however the ability to incorporate gravity only aides in the ease of consistent conveying.

In another aspect of the invention, pulling of the extrudate is done with a single belt system, which utilizes a spring loaded idler wheel to assist in grabbing the exterior of the extrude, but still allows some slip to occur while maintaining an accurate line speed. The spring loaded idler rides on the product and hence the single belt.

In yet other embodiments, it is understood in prior art additional means of cooling may be utilized to cool the extrudate such that it is easier to convey and cut. These means may include water, air or other methods to remove heat from the extrudate.

It should be understood that the heated knife cutter and related conveyor elements may be of varying size and shape without straying from the scope of the present invention.

### BRIEF DESCRIPTION OF THE DRAWINGS

Embodiments of the present invention will now be described by way of example only, with reference to the attached figures wherein:

FIG. 1: Provides a view of an embodiment of the cutting machine which is the subject of this disclosure.

FIG. 2: Provides an elevation view of an embodiment of the conveyor.

FIG. 3: Provides a frontal view of an embodiment of the cutting machine disclosed herein.

FIG. 4: Provides a perspective frontal view of another embodiment of the cutting machine.

FIG. 5 Provides an elevation view of an embodiment of a cutting blade or knife.

### DETAILED DESCRIPTION

Extruded products are typically pulled with a pulling machine called a puller or conveyor. The puller utilizes a pair of electrically driven belts, operating similar to a pinch wheel assembly. In other words, the belts operate simultaneously in speed and clamp on the out surface of the extrusion to create grip, which results in a pulling force. The puller helps set the speed of the extrusion and it is important that the belts have adequate friction on the product that there is no slip.

The product being pulled (extrudate) may then need to be cut to length. This is performed by a cutting device commonly on the same frame as the pulling machine. They may also be two separate machines or frames, but they still work together in unison to cut the product to length. The cutting device may utilize a rotating knife or a shear style cutting action. For profile extrusions the rotating knife is most common. Varying size motors will drive the knife and the knife may be of varying geometry to produce the desired cut quality. Performance of the rotating knife is limited in regards to how many extrusions may be cut at one time. Performance may also be limited when the extrudate being cut is thin walled and low durometer. The results typical to this are the cutting machine will fail to properly cut the product because it is stretchy and will not properly expel itself from the cutting machine. This is especially true of soft wax extrusions of short length and hollow bore.

The ability to cut the wax (and other low melt strength) extrusions crisp, square and rapidly has become necessary and now possible with the current disclosure of an electrically heated blade paired with belt driven pulling machine. This cost effective method allows the machinery to easily accommodate a varying number of strands being extruded at a given time, while not sacrificing quality and squareness of the cuts. The cutting machine described herein can allow the machine to perform short, clean consistent square cuts on wax extrusions of hollow bore. The machine can produce clean, square cuts on a single strand extrudate or on a plurality of which running simultaneously.

The cutting machine of this disclosure utilizes a heated cutting blade to cause the blade to easily slice through the material to be cut. In most embodiments, a conveyor operates to pull or otherwise move the material through a bushing, and at an opposite end of the bushing the heated blade cuts the material. The cutting blade may be heated in varying manners. In some embodiments using electrical heating of the cutting blade, it may be advantageous to electrically insulate the blade from a remainder of the machine. As will be detailed in the figures, multiple elongate material pieces may be cut by a blade simultaneously. A control system may be employed which is operable to adjust variables of machine operation including, but not limited to conveyor speed, conveyor or machine angle, cutting blade speed, cutting blade temperature, bushing temperature and the like. Typically, the cutting blade may be heated to a temperature at or above a melting point of the material to be cut, which increases the cleanliness and effectiveness of the cut. Similarly, in embodiments having a heated bushing, the bushing may be heated to a temperature at or above the melting point of the material to be cut.

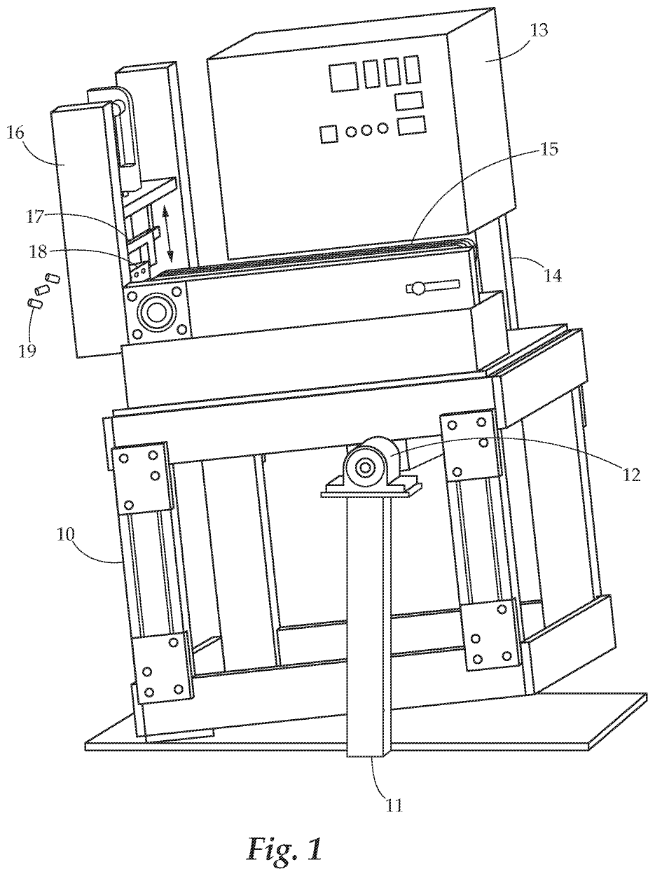

Turning now to FIG. 1, a side view of an embodiment of the cutting machine is provided. The cutting machine has a frame 10 to provide support and structure to the machine and its components. Conveyor 15 is positioned and configured to move in a direction indicated by arrow and pulls any material thereon. Downstream of the conveyor is a bushing 18 which receives the material after the conveyor 15 and aligns it for cutting by passing the material through a hole. In this view, the bushing 18 has three holes to receive three extruded pieces. A controller 13 allows for control of various adjustable features of the machine. Among other control options, a length of the material cut may be controlled by one or a combination of a speed of the conveyor and a rate of movement of the cutting blade. Controller 13 is shown supported on frame 10 by arm 14. Cutting blade 17 is movable upwards and downwards in this embodiment, and is positioned just past the bushing. In a similar embodiment the cutting blade may be movable side to side, or at an angle, or may rotate, without straying from the scope of the invention. Upon a cutting swipe of the heated cutting blade 17, material extending outward from the end of the bushing is cut, resulting in cut pieces 19. Movement of blade 17 may be via pneumatic, electronic, motorized, spring loaded, cam operated, piston operated, and the like. Heating of the cutting blade 17 may be achieved in varying manners disclosed throughout this disclosure, and typically by a heater which is operable to heat the cutting blade.

Generally this cutting machine cuts extruded elements, but of course other material may be cut without straying from the scope of this invention. The cutting blade 17 may be heated in any number of manners. In many embodiments, heating is achieved by passing an electrical current across the cutting blade 17, with heat being generated to due to electrical resistance. Accordingly a connection (via wires, other conductive materials, and the like) of an electrical power source to the cutting blade operates as a heater, in this embodiment. In other embodiments, heating may be achieved by conduction of a heated element to the cutting blade 17, including by chemical or electrical methods. In still other embodiments, heating of the blade may be achieved by any electrical, chemical, or other methods, using direct heating, or indirect heating, including convection, conduction, induction, and the like.

A leg 11 depends downward from frame 10 and is pivotable about hinge 12. The leg 11 and hinge 12 allows for the entire machine, and the conveyor 15 thereon to be tilted such that the conveyor is above a bushing and/or such that the conveyor is tilted downward in its direction of conveyance. In one embodiment, leg 11 may be telescoping in length. In a further embodiment, the telescoping length of the leg 11 may be controlled by a motor to extend and retract the leg. This allows material on the conveyor to be moved with the assistance of gravity. Of course, other embodiments to achieve tilting of the conveyor may be employed, such as adjusting the conveyor itself, without straying from the scope of this disclosure.

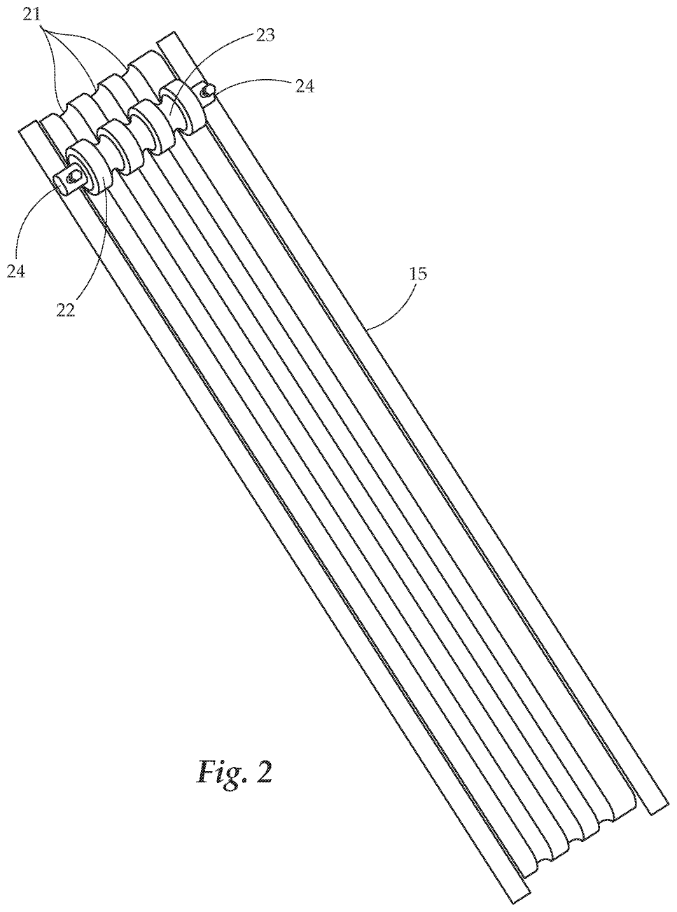

FIG. 2 provides an elevation view of an embodiment of the conveyor. The conveyor 15 is formed as a belt which rotates to provide continuous movement, and moves anything on it in the direction of motion. This embodiment of the belt has three grooves 21 sided to receive three extruded tubes. Of course other embodiments may have more or fewer grooves of different sizes and shapes without straying from the scope of this disclosure. The grooves 21 are shaped to match an extruded profile of the material to be cut. As such, the grooves 21 have increased surface area contacting the material compared to a flat conveyor. This increased surface area causes increased friction, which allows the conveyor to more effectively and gently pull the material without appreciable deformation or damage. An idler wheel 22 is positioned above the conveyor 15 at a point where it will engage with a top of the material conveyed on the conveyor. The idler 22 aids in positioning and drawing the material along the conveyor. In this embodiment, the idler wheel 22 is rotatable and supported by supports 24 on each end. Also in this embodiment, idler wheel 22 is equipped with grooves 23 formed into its surface which are sized to receive three extruded tubes (or other profile), similarly to the grooves 21 of the conveyor 15. In some embodiments, the idler wheel 22 may be spring loaded, or rests on the material under its own weight via gravity, so as to gently press on the material and/or conveyor belt 15. Tension of this spring loading on the idler wheel may be adjustable to allow for some slip between the material on the conveyor and the belt surface. As such, the speed of the conveyor belt 15 may be faster than a movement of the material thereon, to create a controlled slip on the surface of the material. This allows the conveyor and idler wheel to gently pull the somewhat fragile material along without damage. The conveyor may be made of any material, for example rubber, urethane, polymer, metal, and the like.

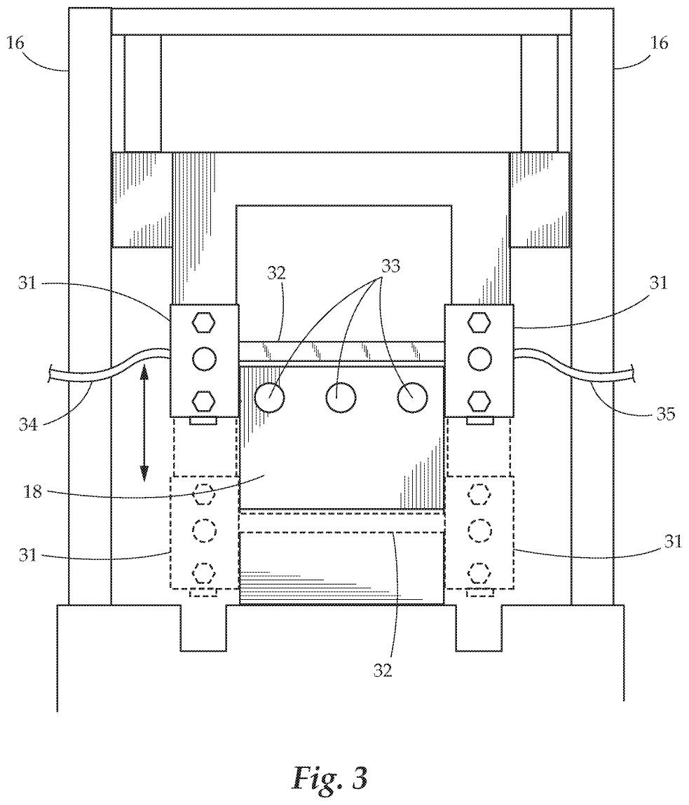

FIG. 3 provides a frontal view of an embodiment of the cutting machine. In this view, the cutting blade is shown as a reciprocating knife 32. The knife 32 has two sharpened cutting faces on opposing sides. The knife 32, in this embodiment, is connected at each end to a support base 31. Each base 31 is movable along upright 16 to move in reciprocating fashion, in this embodiment, up and down. In other embodiments, the upright 16 may be oriented horizontally instead of vertically, or at any angle. As shown in the broken lines, the knife assembly comprising the knife 32 and bases 31 moves along the uprights between top to bottom positions past bushing 18. As such, the reciprocating knife 32 moves in reciprocal motion past the bushing 18 in both directions of travel, thereby cutting any material extending through the bushing openings 33. As noted, other embodiments may utilize side to side motion or other reciprocating motions without straying from the scope of this disclosure. As such, the knife 32 cuts in both the upward and downward motions. This allows for precise, rapid, and efficient cutting and control.

In this embodiment, the reciprocating knife 32 cutting blade is heated electrically. Electric cables 34 and 35 are connected to the knife 32. Upon application of electric current, the electricity passes through conductive reciprocating knife 32. By virtue of the electrical resistance of the knife 32 material, it will be heated to temperature. This temperature can be controlled by, among other options, electrically (voltage/amperage, etc.), or by material selection. In many embodiments, the knife 32, and often but not always the bases 31 are electrically insulated from the uprights 16 and the remainder of the frame, so as not to cause electrical shock risk and to isolate the electricity to the blade circuit only, while preventing additional current from going to ground. In a further embodiment, the bushing itself may be heated using a similar electrical method as with the knife 32, by passing electricity across the conductive bushing 18. The assembly to pass electricity across the bushing 18 generally comprising an electricity source and electric connections (wires, etc.) operates as a bushing heater. In such embodiments, the bushing 18 may also be electrically insulated from the frame 10. Electrical insulation may be achieved by, among other options, providing ceramic or polymeric connectors, spacers, shims, and/or breaks so as to not provide continuous conductive connections throughout the machine. In many embodiment, the materials of the cutting blade, and/or bushing are typically formed of a conductive metal such as steel, which facilitates with both electrical heating embodiments and with heat transfer to the material. However, it should be understood that the cutting blade and bushing may be made of other materials without straying from the scope of this invention.

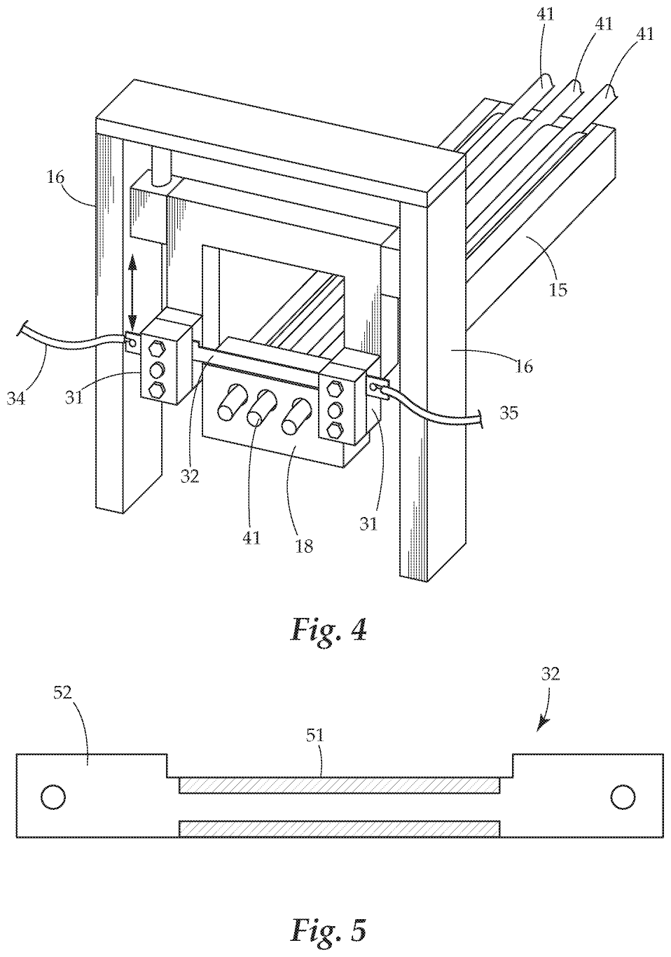

FIG. 4 provides a perspective view of an embodiment of the cutting machine. A material 41, in this view a wax extrudate such as beeswax, soy wax, paraffin wax, and the like, is positioned on the conveyor 14 in each groove 21. The conveyor 15 operates to move the material 41 along and through the holes 33 of the bushing 18. The material 41 extends through the bushing 18. The cutting blade in this embodiment is shown as a reciprocating knife 32. As the knife 32 moves downward, it passes through the material 41 and cuts it. Due to the heating of the cutting blade, it more easily and cleanly cuts the low melt strength material 41 without deformation. In most embodiments, the knife 32 is positioned so as to be very close or in contact with the end of the bushing, though this is not required. In this reciprocating knife embodiment, a similar cutting is achieved in an upward motion as well. Of course, in other embodiments different cutting blade configurations may be used without straying from this invention. In this embodiment, as in the embodiment of FIG. 3, the reciprocating knife 32 cutting blade is heated electrically. Electric cables 34 and 35 are to ends of the knife 32 which extend from the ends of the bases 31. The bases 31, in this embodiment, define apertures through which the blade 32 may pass. An electrically insulating spacer or shim such as silicone, plastic, ceramic, paper, and many others, is positioned between the knife 32 and the bases 31 so that electricity flows directly through the blade from one side to the other. In this embodiment, each base 31 is formed as a multi-part base. The base parts can separate to allow removal of the knife 32 for replacement. The base parts also allow for simple electrical isolation of the knife 32 from the base 31 by placing a shim of non-conductive material on each side of the knife between the two base pieces. Other embodiments may utilize slightly differently arranged multi-part clamping bases, or a single piece base having a seat for the knife, among other configuration, without straying from the scope of this invention. Upon application of electric current, the electric current passes through the conductive reciprocating knife 32. By virtue of the electrical resistance of the knife 32 material, it will be heated to temperature. This temperature can be controlled by, among other options, electrically, knife shape and size, and/or by material selection.

FIG. 5 provides a view of an embodiment of the cutting blade formed as the reciprocal knife. The reciprocal knife 32 has a narrow section 51 at its middle and wider section at each end 52. Electric cables connect to the wider sections, in some cases by being passed through an aperture in the wider sections 52 (not shown). The narrow section 51, but virtue of having a reduced cross sectional area for the electricity to pass through, is able to achieve a higher temperature compared to the wider section 52. This allows a high temperature to be achieved with low electricity demand.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

1. A cutting machine comprising:
a conveyor;
a bushing downstream of the conveyor to receive a material fed to the bushing by the conveyor; and
a cutting blade, wherein the cutting blade is heated during a cutting operation and positioned to cut the material after the material passes through the bushing;
wherein the bushing is heated by a bushing heater, and the bushing heater is operable to heat the bushing to a temperature at or above the melting point of the material to be cut.

2. The cutting machine of claim 1 wherein the cutting blade is a reciprocating knife movable between a first position and a second position, the reciprocating knife having two opposing cutting faces to cut the material when moving between the first position and the second position with a first cutting face, and when moving between the second position and first position with a second cutting face.

3. The cutting machine of claim 1 wherein the cutting blade is heated electrically by passing a current across the cutting blade, and comprising an electrical connection on a first and second opposite sides of the cutting blade causing the current to pass across the cutting blade.

4. The cutting machine of claim 1 wherein the cutting blade is electrically insulated from a machine frame, wherein the machine frame supports the conveyor.

5. (canceled)

6. (canceled)

7. The cutting machine of claim 1 wherein the bushing defines a plurality of openings through which the material may be conveyed, the cutting blade operable to cut any material passing through any of the plurality of openings.

8. The cutting machine of claim 1 further comprising an idler wheel positioned above the conveyor, wherein the idler wheel has a weight and the idler wheel comprises a plurality of grooves, the plurality of grooves of the idler wheel contact the material as it is conveyed by the conveyor.

9. The cutting machine of claim 1 wherein the conveyor defines a channel, wherein the channel engages with a profile of the material positioned on the conveyor.

10. The cutting machine of claim 1 wherein the conveyor can be tilted to have a point on the conveyor elevated above the bushing.

11. The cutting machine of claim 1 further comprising a motor operable to move the conveyor, a speed of the motor adjustable to adjust a speed of the conveyor.

12. The cutting machine of claim 1 further comprising a heater, wherein the heater is operable to control a temperature of the cutting blade.

13. (canceled)

14. (canceled)

15. The cutting machine of claim 1 further comprising an upright positioned adjacent to the bushing, the cutting blade movable along the upright between a first position and a second position.

16. The cutting machine of claim 15 wherein the cutting blade is connected to a base, the base movably connected to the upright.

17. The cutting machine of claim 2 further comprising a pneumatic cylinder operable to move the cutting blade between the first position and the second position.

18. The cutting machine of claim 1 wherein the conveyor defines a plurality of channels, and wherein the bushing defines a plurality of openings, each opening aligned with one of the plurality of conveyor channels.

19. (canceled)

20. (canceled)

21. The cutting machine of claim 8 wherein the plurality of grooves of the idler wheel contact the material due to the weight of the idler wheel causing the idler wheel to rest on the material.
